(19) United States
(12) Patent Application Publication
(10) Pub. No.: US 2025/0200377 A1
(43) Pub. Date: Jun. 19, 2025

(54) Method And Device For User Information Prediction Using Play Log

(71) Applicant: Kakao Games Corp., Gyeonggi-do (KR)

(72) Inventor: Daesub SONG, Gyeonggi-do (KR)

(73) Assignee: Kakao Games Corp., Gyeonggi-do (KR)

(21) Appl. No.: 18/292,864

(22) PCT Filed: Mar. 8, 2023
(86) PCT No.: PCT/KR2023/003140

§ 371 Date: Jan. 26, 2024

(30) Foreign Application Priority Data
Mar. 10, 2022 (KR) 10-2022-0030213

(51) Int. Cl. G06N 3/09; G06Q 30/0241

(52) U.S. Cl. CPC G06N 3/09; G06Q 30/0241

(57) ABSTRACT

Disclosed is a method for predicting user information using playlog data performed by a computing device according to some exemplary embodiments of the present disclosure in order to implement the above-mentioned object. The method may include: training a deep learning model through training data to predict the user information from the playlog data, wherein the training data is generated based on first playlog data of account identification information in which the user information is identified; and predicting the user information related to advertisement identification information from second playlog data of the advertisement identification information by the deep learning model.

### CROSS-REFERENCE TO RELATED APPLICATIONS

This application claims priority to and the benefit of Korean Patent Application No. 10-2022-0030213 filed in the Korean Intellectual Property Office on Mar. 10, 2022, the entire contents of which are incorporated herein by reference.

### TECHNICAL FIELD

The present disclosure relates to a computer technology field, and more particularly, to a method and a device for predicting user information related to advertisement identification information using playlog data.

### BACKGROUND ART

In a mobile app environment, Google and Apple collect user information related to advertisement identification information (e.g., ADID, IDFA) that is unique on a per-device basis, but other companies cannot access such user information. If the user information in the advertisement identification information is not available, marketing based on the advertisement identification information is performed simply based on volume. This is inefficient and not suitable for customized marketing to users.

When performing the marketing based on the advertisement identification information, efficient marketing can be achieved by additionally using user information such as user gender and age in relation to the advertisement identification information. Accordingly, there is a need for a method and a device for predicting user information such as gender and age related to the advertisement identification information.

### SUMMARY OF THE INVENTION

The present disclosure is contrived in response to the above-mentioned background art, and has been made in an effort to provide a method and a device for predicting user information related to advertisement identification information using a game playlog.

An exemplary embodiment of the present disclosure a method for predicting user information using playlog data performed by a computing device in order to implement the above-mentioned object. The method may include: training a deep learning model through training data to predict the user information from the playlog data, wherein the training data is generated based on first playlog data of account identification information in which the user information is identified; and predicting the user information related to the advertisement identification information from second playlog data of the advertisement identification information by the deep learning model.

Alternatively, the user information may include gender information.

Alternatively, the user information may include age information.

Alternatively, the user information may include the gender information and the age information.

Alternatively, evaluation metrics of the deep learning model for prediction of the gender information may be defined by accuracy.

Alternatively, evaluation metrics of the deep learning model for prediction of the age information may be defined by a mean absolute percentage error (MAPE).

Alternatively, the training data may be generated by labeling the user information with respect to the first playlog data.

Another exemplary embodiment of the present disclosure provides a computing device for performing a method for predicting user information using playlog data in order to implement the above-mentioned object. The device may include: a processor including at least one core; and a memory including program codes executable in the processor, and the processor may be configured to train a deep learning model through training data to predict the user information from the playlog data, wherein the training data is generated based on first playlog data of account identification information in which the user information is identified, and predict the user information related to the advertisement identification information from second playlog data of the advertisement identification information by the deep learning model.

Still another exemplary embodiment of the present disclosure provides a computer program stored in a computer-readable storage medium in order to implement the above-mentioned object. When the computer program is executed by one or more processors, the computer program allows one or more processors to perform operations for performing a method for predicting user information using playlog data, the method may include: training a deep learning model through training data to predict the user information from the playlog data, wherein the training data is generated based on first playlog data of account identification information in which the user information is identified; and predicting the user information related to the advertisement identification information from second playlog data of the advertisement identification information by the deep learning model.

The present disclosure is contrived in response to the above-mentioned background art, and a method and a device for predicting user information related to advertisement identification information using playlog data can be provided.

### BRIEF DESCRIPTION OF THE DRAWINGS

FIG. 1 is a block diagram of a computing device for performing a method for predicting user information using playlog data according to some exemplary embodiments of the present disclosure.

FIG. 2 is a schematic view illustrating a network function according to some exemplary embodiments of the present disclosure.

FIG. 3 is a flowchart of a method for predicting user information using playlog data according to some exemplary embodiments of the present disclosure.

FIG. 4 illustrates a graph showing the prediction accuracy of a deep learning model according to some exemplary embodiments of the present disclosure.

FIG. 5 illustrates a graph comparing user information for each of account identification information and advertisement identification information according to some exemplary embodiments of the present disclosure.

FIG. 6 is a simple and normal schematic view of an exemplary computing environment in which some exemplary embodiments of the present disclosure may be implemented.

### DETAILED DESCRIPTION

Various exemplary embodiments are described with reference to the drawings. In the present specification, various descriptions are presented for understanding the present disclosure.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, such implementation decisions should not be interpreted as causing a departure from the scope of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

FIG. 1 is a block diagram of a computing device for performing a method for predicting user information using playlog data according to some exemplary embodiments of the present disclosure.

As illustrated in FIG. 1, the computing device 100 may include a processor 110, a memory 130, and a network unit 150. A configuration of the computing device 100 illustrated in FIG. 1 is only an example shown through simplification. In some exemplary embodiments of the present disclosure, the computing device 100 may include other components for performing a computing configuration of the computing device 100 and only some of the disclosed components may constitute the computing device 100.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data conversion, operation, generation, etc., for data augmentation according to some exemplary embodiments of the present disclosure. For example, the processor 110 may perform steps for performing a method for predicting user information using playlog data described below. Further, according to some exemplary embodiments of the present disclosure, the processor 110 may perform an operation for training a neural network by using training data including the playlog data. The processor 110 may perform calculations for training the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process an operation related to the deep learning model. For example, the CPU and the GPGPU may process the operation related to the deep learning model jointly. Further, in some exemplary embodiments of the present disclosure, processors of a plurality of computing devices may be used together to process data conversion, operation, and generation related to the deep learning model, the learning of the network function and the data classification using the network function. Further, the computer program executed in the computing device according to some exemplary embodiments of the present disclosure may be a CPU, GPGPU, or TPU executable program.

According to some exemplary embodiments of the present disclosure, the memory 130 may store any type of information generated or determined by the processor 110 or any type of information received by the network unit 150. For example, the memory 130 may store data generated in the process of training the deep learning model by the processor 110. Additionally, the memory 130 may store data received externally, such as playlog data of another device by the processor 110. However, the present disclosure is not limited thereto, and the memory 130 may store various information for performing the method for predicting the user information using the playlog data according to some exemplary embodiments of the present disclosure.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to some exemplary embodiments of the present disclosure may use an arbitrary type of known wired/wireless communication system.

The network unit 150 may transmit and receive information processed by the processor 110, a user interface, and the like through communication with other terminals. For example, the network unit 150 may provide the user interface generated by the processor 110 to a client (e.g., a user terminal). In addition, the network unit 150 may receive an external input of a user applied to a client and transfer the external input to the processor 110. In this case, the processor 110 may process operations such as outputting, correcting, changing, adding, and the like of information provided through the user interface based on the external input of the user received from the network unit 150.

Specifically, for example, the network unit 150 may transmit and receive various information for performing the method for predicting the user information according to some exemplary embodiments of the present disclosure. For example, the network unit 150 may receive one or more playlog data or training data stored in the database. Additionally, the network unit 150 may externally transmit some data generated in the process of performing the method for predicting the user information described below to be stored in the database.

Meanwhile, according to some exemplary embodiments of the present disclosure, the computing device 100 may include a server as a computing system that transmits and receives information through communication with the client. In this case, the client may be any type of terminal which may access the server. For example, the computing device 100 which is the server may receive a query from a user terminal and generate a single information processing result corresponding to the query. In this case, the computing device 100 which is the server may provide, to the user terminal, a user interface including the processing result. At this time, the user terminal may output the user interface received from the computing device 100 as the server, and receive or process information through interaction with the user.

In an additional exemplary embodiment, the computing device 100 may also include any type of terminal that receives data resources generated by an arbitrary server and performs additional information processing.

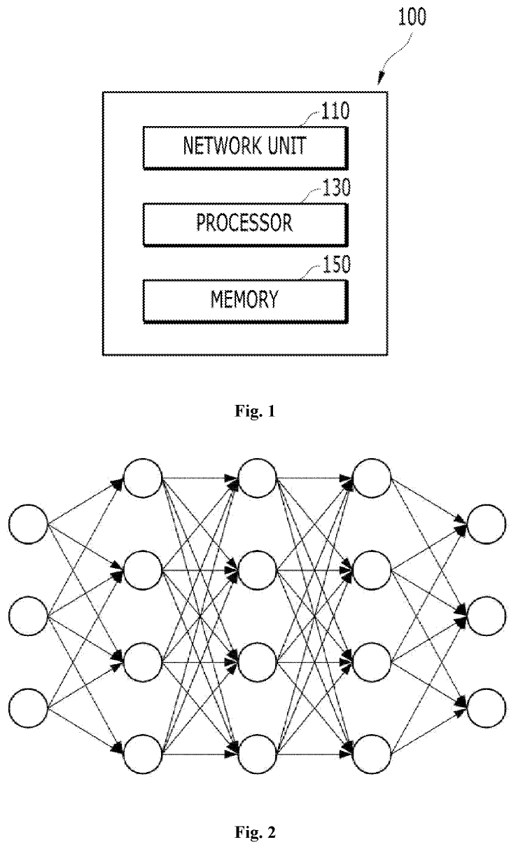

FIG. 2 is a schematic view illustrating a network function according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in 3ddition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

The advertisement identification information may be identification information which is unique on a per-device basis. Currently widely used advertisement identification information includes ‘ADID’ provided by Google's ‘Play Store’ and ‘IDFA’ provided by Apple's ‘APP Store’. Although it is difficult to accurately identify app service users, usage history information left by the app user's device (advertising identification information, to be precise) may be accurately analyzed. In this respect, the advertisement identification information may be an important element in marketing. In order to accurately analyze the history information of the advertisement identification information, user information related to the advertisement identification information may be additionally used. However, it is difficult to obtain the user information related to the advertisement identification information unless it is provided by an app store provider.

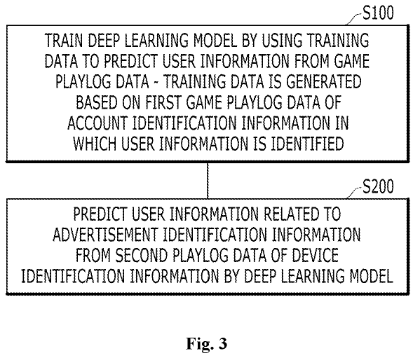

To predict the user information such as the gender and the age in relation to the advertisement identification information, the method of the present disclosure may provide a deep learning model that may predict the user information using the playlog data. Specifically, a game service provider may collect the user information in the process of generating account identification information such as a game ID to play the game. Additionally, the game service provider may collect playlog data for the account identification information in the process of providing the game service. The user information and the playlog data collected in the process of generating the account identification information may be used to efficiently train a prediction model that predicts the user information. The trained prediction model may be used to obtain the user information related to the advertisement identification information from the playlog data of the advertisement identification information. Hereinafter, with reference to FIGS. 3 to 5, a method for predicting user information using playlog data according to some exemplary embodiments of the present disclosure will be described.

FIG. 3 is a flowchart of a method for predicting user information using playlog data according to some exemplary embodiments of the present disclosure.

According to some exemplary embodiments of the present disclosure, the method may include a step s100 of training a deep learning model through training data to predict user information from playlog data. Here, the training data may be generated based on first game playlog data of the account identification information through which user information is identified.

Playlog data may be data containing information about the user's game progress. For example, the playlog data may include information on the game played, a subject who played the game (account identification information, advertisement identification information, a character name, etc.), an action, an action target, time, and information on a location in the game, or an access location (access IP, etc.). The playlog data may be used to determine user tendencies related to games. For example, the playlog data may be used to predict a user's game preference. For example, the playlog data may be used to predict the user's preferred game genre by identifying the genre of a game the user primarily plays.

The playlog data may be generated and stored on a server serving the game while accessing the game. When a user accesses the game using the account identification information, the playlog data may be stored in association with the account identification information. For example, the account identification information may be stored in the playlog data. Here, the account identification information may include a single ID for one game, or an integrated ID that allows access to multiple games with one ID. By analyzing the playlog data of the account identification information, the user's tendency to use account identification information may be predicted.

The user information may be input by the user during or after generating the account identification information. For example, to generate the account identification information, the user information input by the user may include name information, gender information, age information, address information, date of birth information, contact information, etc., of the user. The user information related to the account identification information may be stored on the server along with the playlog data. Using the user information and the play log data for the account identification information, the tendencies of users with specific user information may be predicted. For example, by analyzing the playlog data of the account identification information in which user information indicating a man in his 20s is identified, games preferred by the man in his 20s may be predicted. As another example, by analyzing the playlog data of the account identification information in which user information indicating a woman in her 40s is identified, games preferred by the woman in her 40s may be predicted.

To train the deep learning model to predict user information from the playlog data, the training data may be generated using the playlog data and the user information of account identification information in which the user information is identified. The playlog data of the account identification information in which the user information is identified may be referred to as first playlog data for convenience. In other words, the first playlog data may include playlog data of the account identification information in which user information to be predicted is stored.

According to some exemplary embodiments of the present disclosure, the training data may be generated by labeling the user information with respect to the first playlog data.

For example, in order to train the deep learning model to predict the user's gender and age among the user information, the training data may be generated using playlog data of account identification information in which the user's gender and age are identified. In some examples, the training data may be generated by labeling gender information and age information with respect to data including played game information. In this case, the deep learning model may be trained through the training data to predict the user's gender and age from the played game information. In some other examples, the training data may be generated by labeling the gender information and age information with respect to data including the played game information, access time information, and access location information. In this case, the deep learning model may be trained through the training data to predict the user's gender and age by using the played game information, the access time information, and the access location information. However, the present disclosure is not limited thereto, and the deep learning model may be trained in various ways to predict the user information from the playlog data.

According to some exemplary embodiments of the present disclosure, evaluation metrics of the deep learning model for prediction of the gender information may be defined by accuracy.

The accuracy may be an indicator indicating a degree at which an actual value and a prediction value match among observation values. The accuracy may be calculated as a ratio of correctly predicted data among all data according to the following equation.

$$accuracy = \frac{T P + T N}{P + N} = \frac{T P + T N}{T P + F N + F P + T N} \qquad [ Equation 1 ]$$

However, the present disclosure is not limited thereto, and the evaluation metrics of the deep learning model for the prediction of the gender information may be defined in various ways. The evaluation metrics of the deep learning model for the prediction of the gender information may be used for training, verification, and testing of the deep learning model.

According to some exemplary embodiments of the present disclosure, evaluation metrics of the deep learning model for prediction of the age information may be defined by a mean absolute percentage error (MAPE).

The MAPE may have a percentage value. As the MAPE is closer to 0, the better the model's performance. The MAPE may be calculated according to the following equation.

$$M = \frac{1}{A} {\sum }_{t = 1}^{n} \vert \frac{{A}_{t} - {F}_{t}}{{A}_{t}} \vert \qquad [ Equation 2 ]$$

However, the present disclosure is not limited thereto, and the evaluation metrics of the deep learning model for the prediction of the gender information may be defined in various ways. The evaluation metrics of the deep learning model for the prediction of the age information may be used for training, verification, and testing of the deep learning model.

According to some exemplary embodiments of the present disclosure, the method may include a step of predicting the user information related to the advertisement identification information from second playlog data of the advertisement identification information by the deep learning model.

If the deep learning model is trained to predict the user information, the deep learning model may predict the user information using the playlog data of the advertisement identification information. As described above, the playlog data may be generated and stored on the server serving the game while accessing the game. In this case, the advertisement identification information of the device providing the game may also be stored on the server along with the playlog data. For example, the advertisement identification information may be stored in the playlog data. The advertisement identification information may be identification information which is unique on the per-device basis as described above. The playlog data of the advertisement identification information may be referred to as the second playlog data.

The user information related to the advertisement identification information is not provided and stored on the server that serves the game. As described above, the deep learning model trained using the first playlog data is trained to predict the user information from the playlog data, so the deep learning model may predict the user information related to the advertisement identification information from the playlog data (i.e., the second playlog data) of the advertisement identification information. In this way, the method of the present disclosure may predict the user information related to the advertisement identification information by the deep learning model.

The steps according to the method described above are presented just for description, and some steps may be omitted or separate steps may be added. Further, the steps of the method described above may be performed according to an arbitrary order.

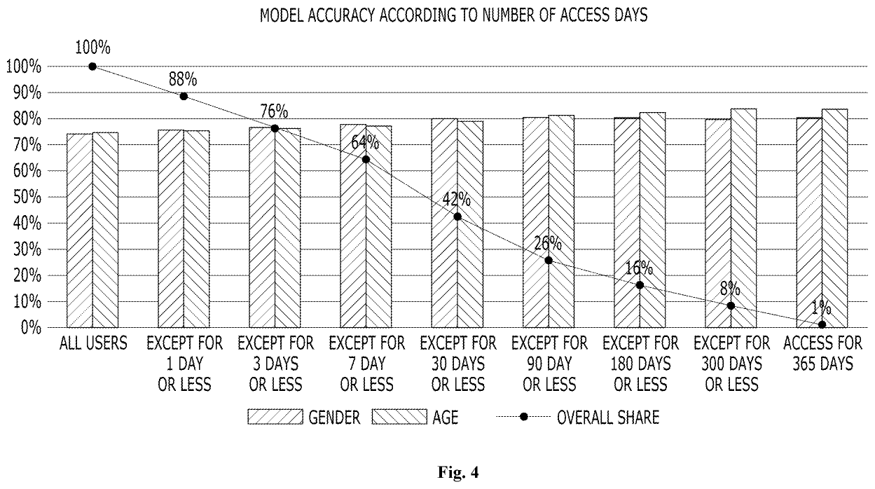

Referring to FIG. 4, a graph showing the prediction accuracy of a deep learning model trained according to the method of the present disclosure. An exemplary deep learning model may be a model that predicts gender and age. As illustrated in FIG. 4, this deep learning model shows an accuracy of over 80% for users who access the game for more than 30 days in a year.

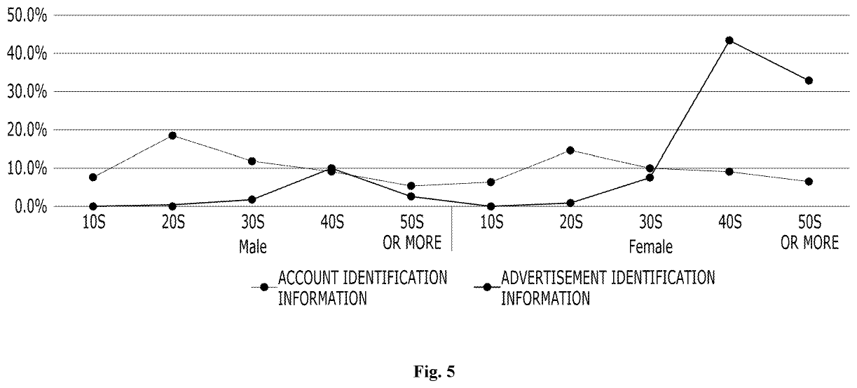

Referring to FIG. 5, a graph comparing user information including the age information and gender information for each of the account identification information and the advertisement identification information is shown. The graph for the account identification information is created using actual data stored on the server, and the graph for the advertisement identification information is created using predicted data from the deep learning model. When looking at the user information related to the account identification information, a distribution with a high proportion of people in their 20s is shown. In contrast, the advertisement identification information shows a distribution with a high proportion of people in their 40s. Customized marketing may be done according to the difference.

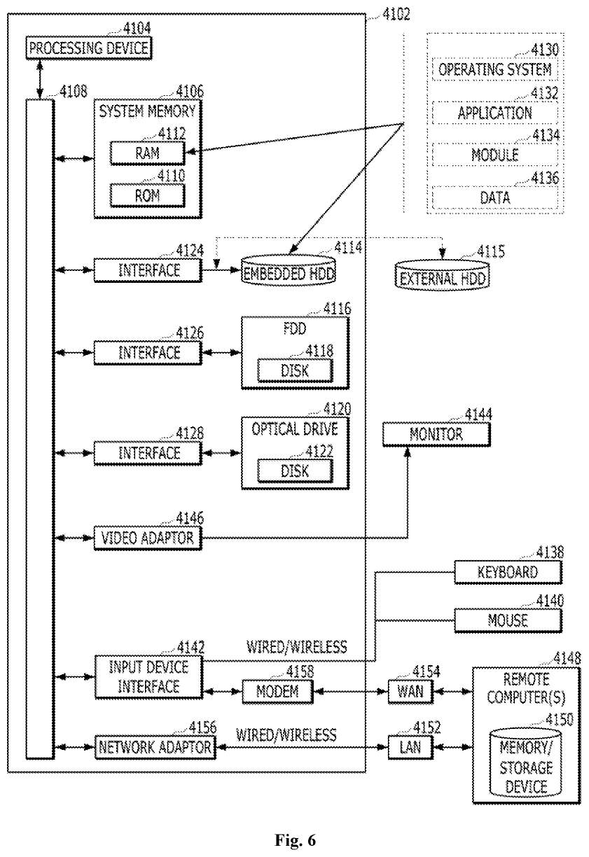

FIG. 6 is a simple and general schematic view of an exemplary computing environment in which exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least three devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

1. A method for predicting user information using playlog data performed by a computing device, the method comprising:
training a deep learning model through training data to predict the user information from the playlog data, wherein the training data is generated based on first playlog data of account identification information in which the user information is identified; and
predicting the user information related to advertisement identification information from second playlog data of the advertisement identification information by the deep learning model.

2. The method of claim 1, wherein the user information includes gender information.

3. The method of claim 1, wherein the user information includes age information.

4. The method of claim 1, wherein the user information includes the gender information and the age information.

5. The method of claim 2, wherein evaluation metrics of the deep learning model for prediction of the gender information is defined by accuracy.

6. The method of claim 3, wherein evaluation metrics of the deep learning model for prediction of the age information is defined by a mean absolute percentage error (MAPE).

7. The method of claim 1, wherein the training data is generated by labeling the user information with respect to the first playlog data.

8. A computing device for performing a method for predicting user information using playlog data, comprising:
a processor including at least one core; and
a memory including program codes executable in the processor, P1 wherein the processor is configured to
train a deep learning model through training data to predict the user information from the playlog data, wherein the training data is generated based on first playlog data of account identification information in which the user information is identified, and
predict the user information related to advertisement identification information from second playlog data of the advertisement identification information by the deep learning model.

9. A computer program stored in a computer-readable storage medium, wherein when the computer program is executed by one or more processors, the computer program allows one or more processors to perform operations for performing a method for predicting user information using playlog data, the method comprises:
training a deep learning model through training data to predict the user information from the playlog data, wherein the training data is generated based on first playlog data of account identification information in which the user information is identified; and
predicting the user information related to advertisement identification information from second playlog data of the advertisement identification information by the deep learning model.
